(19) United States
(12) Patent Application Publication
(10) Pub. No.: US 2026/0015865 A1
(43) Pub. Date: Jan. 15, 2026

(54) VERTICAL ROOF FLASHING FOR PVC PIPE

(71) Applicant: Roof Goose Vent LLC, North Kingstown, RI (US)

(72) Inventor: Jack F. KING, JR., North Kingstown, RI (US)

(73) Assignee: Roof Goose Vent LLC, North Kingstown, RI (US)

(21) Appl. No.: 19/262,874

(22) Filed: Jul. 8, 2025

Related U.S. Application Data
(60) Provisional application No. 63/670,201, filed on Jul. 12, 2024.

(51) Int. Cl. E04D 13/14; F16L 5/10

(52) U.S. Cl. CPC E04D 13/1407; F16L 5/10

(57) ABSTRACT

The invention is a temporary flashing for plumbing pipes extending through a flat roof. The flashing provides an inexpensive plumber supplied seal that can be installed and left in place under a permanent roof flashing provided by a roofer at a later time. The flashing comprises a plastic core base and a plastic core sleeve as one or two pieces. The base and the sleeve are overmolded with a flexible rubber.

### RELATED APPLICATION

This application claims the benefit of U.S. Provisional Application Ser. No. 63/670, 201, filed Jul. 12, 2024, entitled “Vertical Roof Flashing for PVC Pipe,” which is incorporated herein by reference in its entirety.

### FIELD OF THE INVENTION

The present invention relates to a vertical roof flashing for PVC pipe. More particularly, the invention relates to a temporary vertical roof flashing for PVC pipe going through a flat roof.

### BACKGROUND OF THE INVENTION

PVC plumbing pipe, such as Schedule 40 drainage pipe, extends through a flat roof up to about 3 feet. Usually, the plumber will install the PVC pipe extending it through a hole created by the plumber in the flat roof. The PVC pipe is then left for a roofer to install a flashing to cover and seal the pipe to the roof. The roofer must also secure the roof membrane at the hole to prevent lifting of the membrane. The pipe is reasonably small and tends to pivot when going through the roof making it difficult for a roofer to install the flashing to the PVC pipe, e.g. the pipe tends to deflect or break when the roofer places the flashing over the pipe, thereby causing delay and expense. Additionally, if the roofer is delayed and the plumber does not seal (caulk) the area around the pipe, rain or other elements may damage the structure of the building. This makes penetrating the roof weather dependent.

More specifically, the PVC pipe riser must penetrate a number of layers when it leaves the inside of the building and goes through the flat roof. The pipe will penetrate a plywood deck, or a metal deck on commercial buildings, and then pass through a certain thickness of insulation and then through the roofing membrane in order to reach daylight on the roof. Because the PVC riser usually only passes through a single layer of deck, it is prone to pivot within the roof riser hole which makes plumbing it difficult, unless it is well supported below the roof. As noted above, the pipe being generally 3 feet above the flat roof makes it difficult for the roofer to apply the flashing resulting in pipe breakages or fittings breaking below the roof.

U.S. Pat. No. 9,255,412 discloses a peripheral sealing gland. However, this product has limitations in use.

These known methods of installing and flashing PVC pipe have various shortcomings. These shortcomings are addressed by the present invention.

### SUMMARY OF THE INVENTION

The invention is directed to a vertical roof flashing for PVC pipe. The invention is a temporary flashing for plumbing pipes extending through a flat roof. The invention provides an inexpensive plumber supplied seal that can be installed and left in place until a permanent roof flashing is provided by a roofer at a later time.

An object of the invention is to provide a temporary flashing for plumbing pipes extending through a flat roof.

Another object of the invention is to provide an inexpensive plumber supplied seal that can be installed and left in place under a permanent roof flashing provided by a roofer at a later time.

Another object of the invention is to provide a temporary flashing for plumbing pipes extending through a flat roof which provides lateral support to the PVC pipe when installing the permanent flashing.

Another object of the invention is to provide a temporary flashing for plumbing pipes extending through a flat roof which does not require caulk or an adhesive.

Another object of the invention is to provide a temporary flashing for plumbing pipes extending through a flat roof which will hold down the roof membrane and prevent lifting of the membrane.

Another object of the invention is to provide a temporary flashing for plumbing pipes extending through a flat roof having a plastic core and an overmolded soft durometer rubber material.

The temporary vertical roof flashing for PVC pipe comprises a plastic core base and a plastic core sleeve, which may be one or two pieces. The base and the sleeve are overmolded with a flexible rubber. The temporary flashing covers and seals the PVC pipe until a roofer installs a permanent flashing over the temporary flashing. It also serves to hold down the roof membrane.

These primary and other objects of the invention will be apparent from the following description of the preferred embodiments of the invention and from the accompanying drawings.

### BRIEF DESCRIPTION OF THE DRAWINGS

The following detailed description of the specific non-limiting embodiments of the present invention can be best understood when read in conjunction with the following drawings, where like structures are indicated by like reference numbers.

Referring to the drawings:

FIG. 1A is a perspective view of the roof flashing of the invention.

FIG. 1B is a side vertical view of FIG. 1A.

FIG. 1C is a bottom view of FIG. 1A.

FIG. 1D is a top view of FIG. 1A.

FIG. 1E is a cross-sectional view taken along lines 1D-1D of FIG. 1D.

FIG. 2A is a perspective exploded view of the flashing of FIG. 1A.

FIG. 2B is a side view of FIG. 2A.

FIG. 3A is a perspective view of the sleeve member of the flashing.

FIG. 3B is a vertical side view of FIG. 3A.

FIG. 3C is a bottom view of FIG. 3A.

FIG. 3D is a top view of FIG. 3A.

FIG. 4A is a perspective view of the base member of the flashing.

FIG. 4B is a vertical side view of FIG. 4A.

FIG. 4C is a top view of FIG. 4A.

FIG. 4D is a bottom view of FIG. 4A.

FIG. 5A is a perspective view of the roof flashing of FIG. 1 installed on a pipe extending upwardly from a flat roof.

FIG. 5B is a close-up side view of FIG. 5A.

FIG. 5C is a partial top view of the roof flashing of FIG. 5A.

FIG. 5D is a cross-sectional view taken along lines 5D-5D of FIG. 5C.

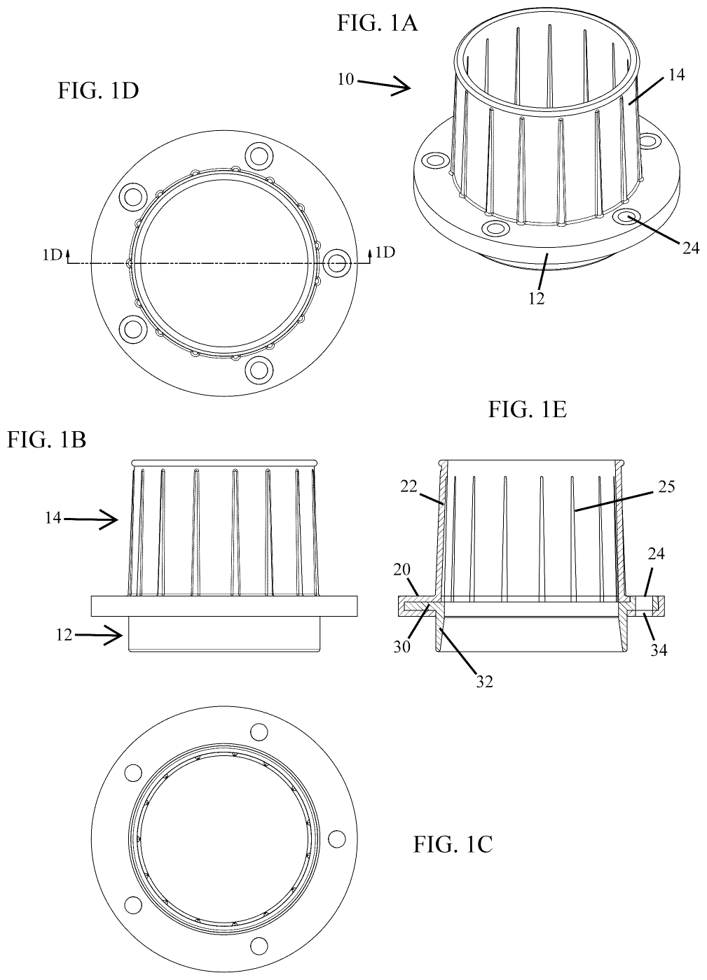

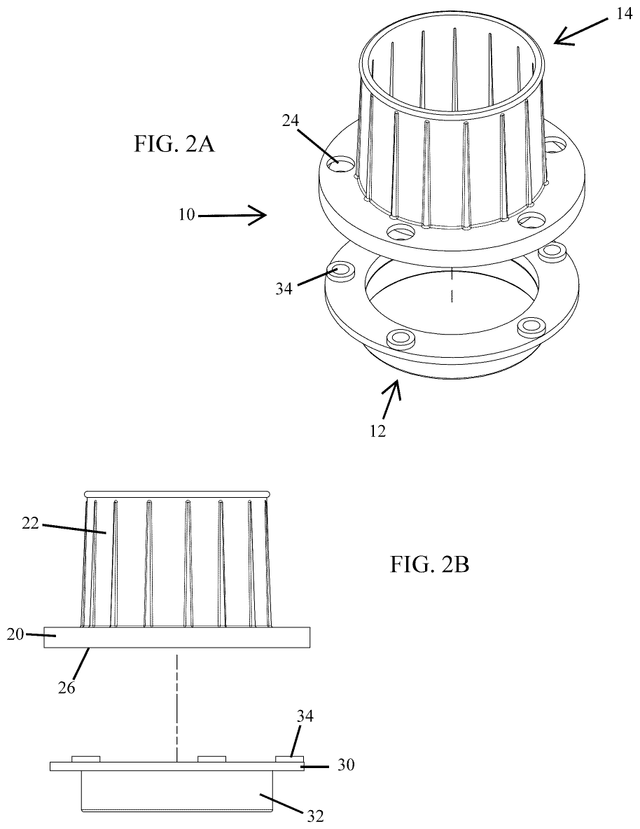

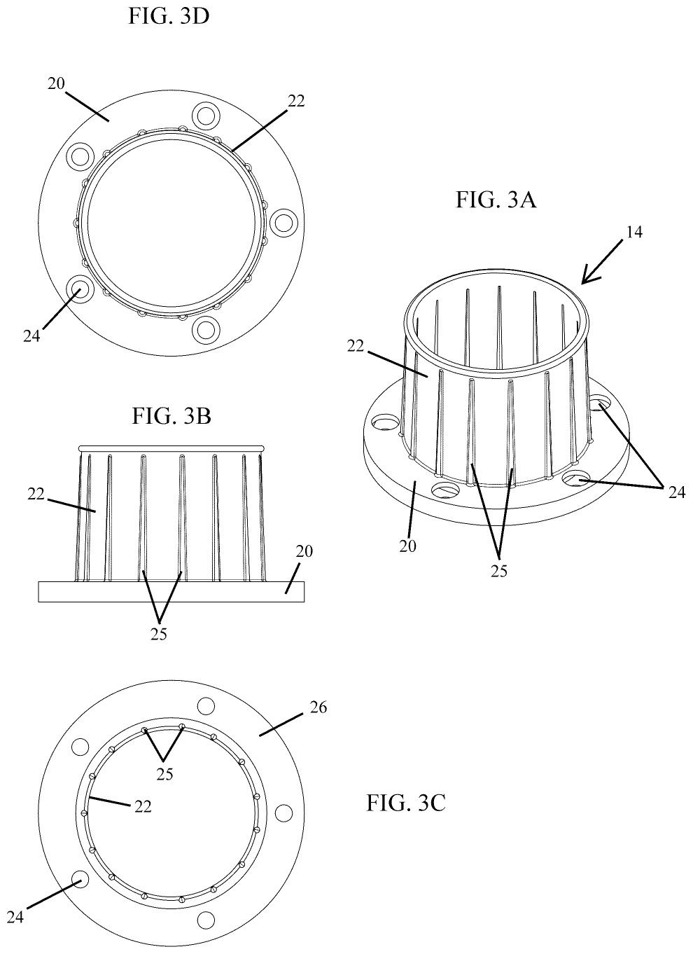

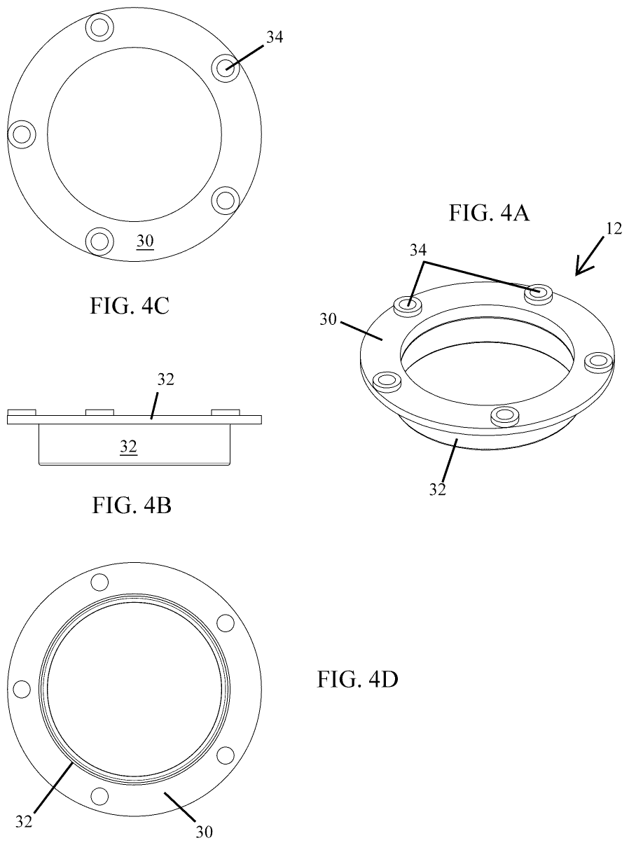

### DETAILED DESCRIPTION OF THE PREFERRED EMBODIMENTS

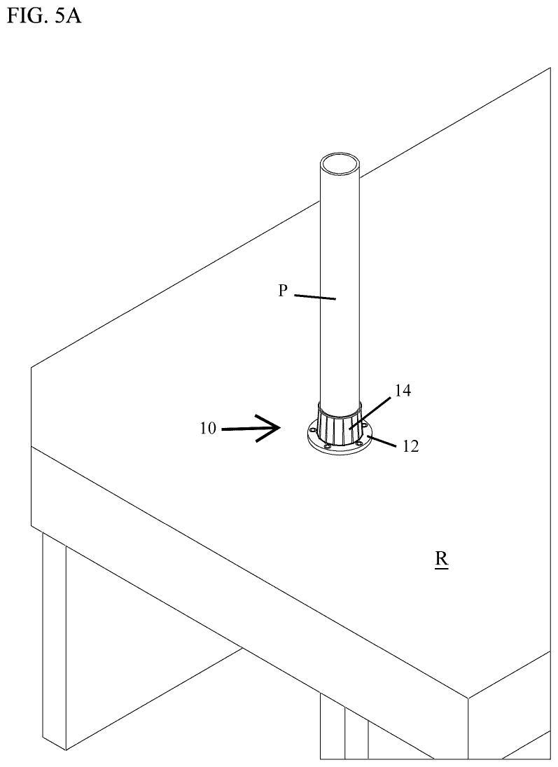

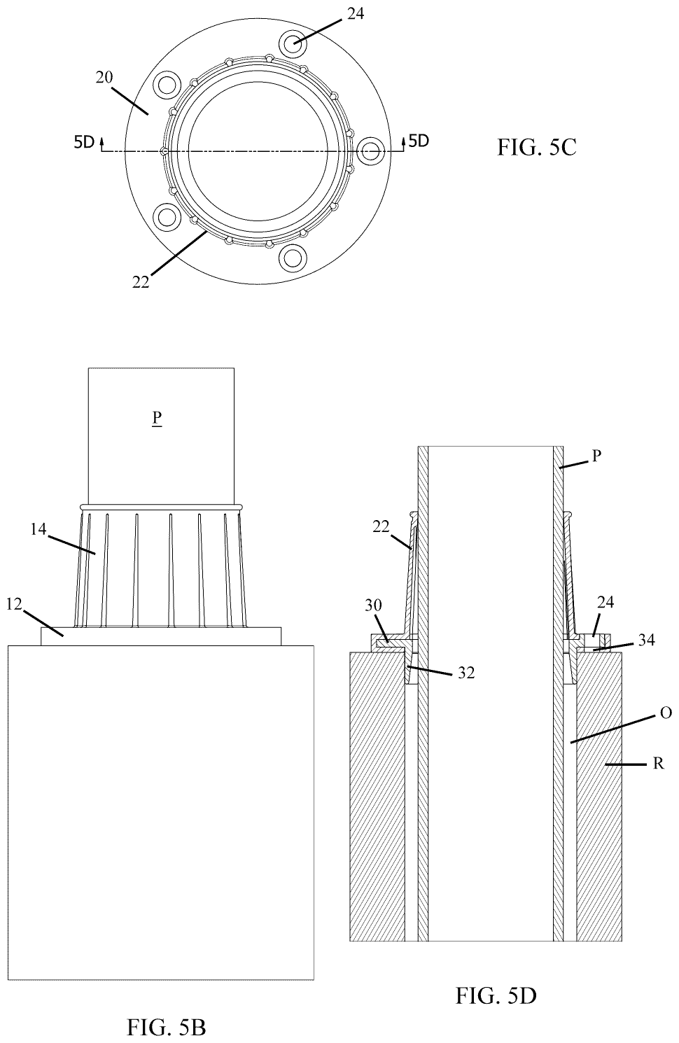

The invention is directed to a vertical roof flashing for PVC pipe. The flashing is a temporary flashing to cover plumbing PVC pipe extending through a flat roof as shown in FIGS. 5A-5D. The flashing may be free of caulk and adhesive. It provides an inexpensive plumber supplied seal that can be installed and left in place under the permanent roof flashing provided by a roofer at a later time, thereby protecting the PVC pipe and the building from the elements until the permanent flashing is installed.

The temporary roof flashing 10 comprises a base member 12 and a sleeve member 14. The temporary flashing 10 is made to fit specific size PVC Schedule 40 piping and provides support for the piping when installing the permanent flashing. The sleeve member 14 has a plastic core, such as ASA (acrylic-styrene-acrylonitrile copolymer), and is overmolded with a soft durometer rubber material such as thermoplastic elastomer, e.g. Santoprene®. The base member 12 similarly comprises a ASA plastic core overmolded with a soft durometer rubber material such as Santoprene®.

Referring to the figures, the sleeve member 14 comprises a flange 20 and a vertical tubular section 22. Flange 20 includes five apertures 24 for receiving fasteners such as screws. Tubular section 22 includes ribs 25 to provide support. The vertical tubular section 22 fits snuggly around the PVC piping. The bottom 26 of flange 20 is sized to mate on top of base member 12.

The base member 12 comprises a flange 30 which mates with the bottom 26 of flange 20 and a downwardly extending annular wall 32 which seats in the roof opening through which the PVC pipe extends. Flange 30 includes apertures 34 which mate with apertures 24 of sleeve member 14.

Referring to FIGS. 5A-5D, in use, after the plumber brings the PVC plumbing pipe P through the flat roof R, base member 12 is inserted over the PVC pipe and fits into the roof opening O by member 32. Flange member 30 seats on the flat roof R. This provides lateral support to the pipe due to the vertical section being laterally braced in two locations, namely the opening O in the deck and the base member 12. This dual support provides vertical rigidity to the vertical PVC pipe. Thereafter, sleeve member 14 is inserted over the PVC pipe and screws (not shown) are inserted through the apertures 24 and 34 of flanges 20 and 30 to attach the temporary flashing to the roof. The molded plastic core provides the flashing strength so that the screws pull it down and creates a pressure seal against the roof membrane as well as at the outlet of the flashing against the PVC pipe that it protects. This also holds down the roof membrane. Any taper in the overmolded seal provides ease of pulling the flashing over the PVC pipe. The actual seal surface is created by the soft durometer overmolding of the rigid core. Thereafter, the temporary flashing 10 covers and seals the PVC pipe until the roofer installs a permanent flashing over the temporary flashing 10.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

1. A temporary roof flashing for a pipe extending upwardly from a flat roof to cover and seal the pipe until a roofer installs a permanent flashing over the temporary roof flashing comprising a plastic base adapted to fit over the pipe and an opening in the flat roof from which the pipe extends and a plastic sleeve adapted to fit over the pipe and attach to the plastic base, wherein the temporary roof flashing covers and seals the pipe until the roofer installs the permanent flashing over the temporary roof flashing.

2. The temporary roof flashing of claim 1 wherein the plastic base and the plastic sleeve are comprised of a plastic core overmolded with a soft durometer rubber.

3. The temporary roof flashing of claim 2 wherein the plastic core comprises acrylic-styrene-acrylonitrile and the overmolded soft durometer rubber comprises thermoplastic elastomer.

4. The temporary roof flashing of claim 1 wherein the plastic base comprises a flange for covering the opening in the flat roof.

5. The temporary roof flashing of claim 4 wherein the plastic base further includes a downwardly extending wall from the flange adapted to seat in the roof opening.

6. The temporary roof flashing of claim 5 wherein the flange of the plastic base includes apertures for receiving fasteners.

7. The temporary roof flashing of claim 1 wherein the plastic sleeve comprises a flange and upwardly extending tubular section.

8. The temporary roof flashing of claim 7 wherein the flange of the plastic sleeve includes apertures for receiving fasteners.

9. The temporary roof flashing of claim 8 wherein the tubular section includes a plurality of ribs.

10. The temporary roof flashing of claim 1 wherein the temporary flashing does not require caulk or an adhesive.

11. A temporary roof flashing for a pipe extending upwardly from a flat roof to cover and seal the pipe until a roofer installs a permanent flashing over the temporary roof flashing comprising
a plastic base adapted to fit over the pipe and an opening in the flat roof from which the pipe extends comprising a flange for covering the opening in the flat roof and a downwardly extending wall from the flange adapted to seat in the roof opening, and
a plastic sleeve adapted to fit over the pipe and attach to the plastic base comprising a flange and upwardly extending tubular section,
wherein the temporary roof flashing covers and seals the pipe until the roofer installs the permanent flashing over the temporary roof flashing.

12. The temporary roof flashing of claim 11 wherein the plastic base and the plastic sleeve are comprised of a plastic core overmolded with a soft durometer rubber.

13. The temporary roof flashing of claim 12 wherein the plastic core comprises acrylic-styrene-acrylonitrile and the overmolded soft durometer rubber comprises thermoplastic elastomer.

14. The temporary roof flashing of claim 13 wherein the flange of the plastic base includes apertures for receiving fasteners.

15. The temporary roof flashing of claim 14 wherein the flange of the plastic sleeve includes apertures for receiving fasteners.

16. The temporary roof flashing of claim 15 wherein the tubular section includes a plurality of ribs.

17. The temporary roof flashing of claim 11 wherein the temporary flashing does not require caulk or an adhesive.
